(19) United States
(12) Patent Application Publication
(10) Pub. No.: US 2010/0067148 A1
(43) Pub. Date: Mar. 18, 2010

(54) Thin film magnetic head having a pair of magnetic layers whose magnetization is controlled by shield layers

(75) Inventors: Yoshihiro Tsuchiya, Tokyo (JP); Tsutomu Chou, Tokyo (JP); Shinji Hara, Tokyo (JP); Daisuke Miyauchi, Tokyo (JP); Takahiko Machita, Tokyo (JP)

Correspondence Address: POSZ LAW GROUP, PLC, 12040 SOUTH LAKES DRIVE, SUITE 101, RESTON, VA, 20191, US

(73) Assignee: TDK CORPORATION, Tokyo (JP)

(21) Appl. No.: 12/232,332

(22) Filed: Sep. 16, 2008

(51) Int. Cl. G11B 5/33; G11B 5/48

(52) U.S. Cl. 360/245.3; 360/319; G9B/5.104; G9B/5.147

(57) ABSTRACT

A thin film magnetic head comprises an MR laminated body that has first and second magnetic layers, a nonmagnetic middle layer, and the first and second magnetic layers and the nonmagnetic middle layer are laminated to make contact with each other in respective order. First and second antiferromagnetic layers are provided with the first and second magnetic layers respectively. The first antiferromagnetic layer and/or the second antiferromagnetic layer contains a void part or a thin portion at least in a portion of the projection area toward the orthogonal direction to the film surface of the MR laminated body.

### BACKGROUND OF THE INVENTION

1. Field of the Invention

The present invention relates to a thin film magnetic head, and particularly relates to a device structure of the thin film magnetic head comprising a pair of magnetic layers where a magnetization direction is changed according to an external magnetic field.

2. Description of the Related Art

Associated with high recording density of a hard disk drive (HDD), a supersensitive and high-power head is in demand. As a head fulfilling this request, a spin-valve head has been invented. A pair of ferromagnetic layers via a nonmagnetic middle layer are formed in this spin-valve head. An antiferromagnetic layer is arranged to make contact with one of the ferromagnetic layers, and the magnetization direction of the ferromagnetic layer is fixed to one direction due to an exchange-coupling with the antiferromagnetic layer. In the other ferromagnetic layer, its magnetization direction freely rotates according to the external magnetic field. This ferromagnetic layer is also referred to as a free layer. In the spin-valve head, a change in magneto-resistance is realized by a change in a relative angle of spins in these two ferromagnetic layers. The pair of ferromagnetic layers are interposed by a pair of shield layers, and an external magnetic field from an adjacent bit on the same track of a recording medium is blocked.

The exchange-coupling between the antiferromagnetic layer and the ferromagnetic layer is one of the essential characteristics in the spin-valve head. However, further high recording density advances, and when a read gap (width of signal in a traveling direction of a medium when the medium signal is read by a magnetic head, which is correlated to a thickness of a film interposed between shields) becomes approximately 20 nm, there is no space to contain the antiferromagnetic layer within the read gap. Then, a technology to control the magnetization direction of the ferromagnetic layer and to change a relative angle formed with the magnetization directions of two ferromagnetic layers according to the external magnetic field in some way is required. A thin film magnetic head having two free layers whose directions of magnetization change according to the external magnetic field and a nonmagnetic middle layer interposed by these free layers is disclosed in the specification of U.S. Pat. No. 7,035,062. The two free layers are exchange-coupled according to RKKY (Rudermann, Kittel, Kasuya and Yoshida) interaction via the nonmagnetic middle layer, and they are magnetized in antiparallel to each other in the state where no magnetic field is applied at all (hereafter, this state is referred to as a magnetic field-free state). A bias magnetic field application means is formed on rear surfaces of the two free layers and the nonmagnetic middle layer viewed from the air bearing surface (ABS), and a bias magnetic field is applied in a direction at right angles to the air bearing surface. The magnetization directions of the two free layers form a constant relative angle due to the magnetic field from the bias magnetic field application means. When an external magnetic field in the direction at right angles to the air bearing surface is provided from the recording medium, the magnetization directions of the two free layers are changed, and as a result, the relative angle formed with the magnetization directions of the two free layers is changed and electrical resistance to the sense current is changed. It becomes possible to detect the external magnetic field by utilizing this characteristic. As described above, in the film configuration using the two free layers, because the antiferromagnetic layer becomes unnecessary, there is potential where the film configuration is simplified and the reduction of a read gap becomes easy. In this specification, “parallel” means that magnetization directions are in parallel with each other and both components are orientated toward the same direction, and “antiparallel” means that magnetization directions are in parallel with each other; however, both components are oriented toward an opposite direction from each other.

However, in the thin film magnetic head of a type having two free layers magnetically tied due to the RKKY interaction, a material utilizing as a nonmagnetic middle layer is limited and the improvement of a rate of change in magneto-resistance cannot also be expected. For example, Cu achieves the RKKY effect and has superior spin conduction; however, because the resistance is too low, it is not the most appropriate as a nonmagnetic middle layer in the film configuration using the two free layers. Then, another technology to magnetize the two free layers to the directions of antiparallel from each other becomes required.

### SUMMARY OF THE INVENTION

The present invention targets a thin film magnetic head having an MR laminated body where a first magnetic layer (free layer) whose magnetization direction is changed according to an external magnetic field, a nonmagnetic middle layer, and a second magnetic layer (free layer) whose magnetization direction is changed according to the external magnetic field are arranged in respective order to make contact with each other; and a bias magnetic field application means that is formed on an opposite surface from the air bearing surface of the MR laminated layer and that applies a bias magnetic field orthogonal to the air bearing surface to the MR laminated body. The objective of the present invention is to provide a thin film magnetic head where a high rate of change in magneto-resistance can be obtained by controlling the magnetization directions of two magnetic layers in a magnetic field-free state to antiparallel directions to each other without relying upon a magnetic interaction between these magnetic layers, and where the rate of change in magnetization resistance varies less, and where reduction of the read gap is easy.

The thin film magnetic head according to one embodiment of the present invention has an MR laminated body that has a first magnetic layer whose magnetization direction is changed according to an external magnetic field, a nonmagnetic middle layer, and a second magnetic layer whose magnetization direction is changed according to the external magnetic field, and where the first magnetic layer, the nonmagnetic middle layer, and the second magnetic layer are laminated to make contact with each other in respective order; first and second shield layers each of which is provided to face the first magnetic layer and the second magnetic layer, respectively, and which are arranged in a matter of sandwiching the MR laminated body in an orthogonal direction to a film surface of the MR laminated body, and which function as electrodes for flowing a sense current in the orthogonal direction to the film surface of the MR laminated body, and a bias magnetic field application means that is formed on an opposite surface from an air bearing surface of the MR laminated body and that applies a bias magnetic field in the orthogonal direction to the air bearing surface, to the MR laminated body. The first shield layer has a first exchange-coupling magnetic field application layer that is formed to face the first magnetic layer and that transmits an exchange-coupling magnetic field in parallel to the air bearing surface, to the first magnetic layer; and a first antiferromagnetic layer that is formed on the rear surface of the first exchange-coupling magnetic field application layer viewed from the first magnetic layer to make contact with the first exchange-coupling magnetic field application layer and that is exchange-coupled with the first exchange-coupling magnetic field application layer. The second shield layer has a second exchange-coupling magnetic field application layer that is formed to face the second magnetic layer and that transits an exchange-coupling magnetic field in parallel to the air bearing surface; and a second antiferromagnetic layer is formed on the rear surface of the second exchange-coupling magnetic field application layer viewed from the second magnetic layer to make contact with the second exchange-coupling magnetic field application layer and that is exchange-coupled with the second exchange-coupling magnetic field application layer. The first magnetic layer and the second magnetic layer are magnetized so as to have a magnetization direction in antiparallel to each other in the state where no magnetic field is applied from the outside. Further, the first antiferromagnetic layer and/or the second antiferromagnetic layer contains a void part at least in a portion of the projection area toward the orthogonal direction to the film surface of the MR laminated body. Alternatively, the first antiferromagnetic layer and/or the second antiferromagnetic layer contains a thin portion at least in a portion of the projection area toward the orthogonal direction to the film surface of the MR laminated body.

In the thin film magnetic head having such a configuration, an exchange-coupling magnetic field from the first and second exchange-coupling magnetic field application layers whose directions of magnetization are solidly fixed due to the exchange-coupling with the first and second antiferromagnetic layers, is transmitted to the first and second magnetic layers. The exchange-coupling magnetic field from the first exchange-coupling magnetic field application layer and the exchange-coupling magnetic field from the second exchange-coupling magnetic field application layer can be in antiparallel with each other, and the first and second magnetic layers are magnetized to the antiparallel direction from each other in the magnetic field-free state. However, in actuality, since a bias magnetic filed in the orthogonal direction to the air bearing surface is applied from the bias magnetic field application means, the first and second magnetic layers are magnetized to the intermediate state between the antiparallel and parallel. This magnetization state is regarded as an initial magnetized state, and when the external magnetic field from the recording medium is applied, a relative angle formed with the magnetization directions of the first and second magnetic layers is changed according to the magnitude and orientation of the external magnetic field, and therefore, it becomes possible to detect the external magnetic field utilizing the magneto-resistance effect.

In addition, since the first and second antiferromagnetic layers and the first and second exchange-coupling magnetic field application layers also have a function as a shield layer, respectively, they contribute to the reduction of the read gap. The present invention is featured such that the shield layer, that was not magnetically coupled with the magnetic layers in the prior art, is magnetically coupled with the magnetic layer.

Further, in the present invention, because the first antiferromagnetic layer and/or the second antiferromagnetic layer contains a void part at least in a portion of the projection area toward the orthogonal direction to the film surface of the MR laminated body, or because the first antiferromagnetic layer and/or the second antiferromagnetic layer contains a thin portion at least in a portion of the projection area toward the orthogonal direction to the film surface of the MR laminated body, variation of a rate of change in magneto-resistance can be reduced. This point will be described hereafter.

Although the antiferromagnetic layer has a uniaxial magnetic anisotropy, strictly speaking, each of crystal grains forming the antiferromagnetic layer has a magnetization easy axis, respectively, and the orientation of the magnetization easy axis is not the same, and this causes the variation of the direction of the crystalline magnetic anisotropy. Therefore, in the microscopic sense, the direction of the crystalline magnetic anisotropy varies per crystal grain forming the antiferromagnetic layer. In the macroscopic sense, an exchange-coupling magnetic filed application layer arranged to make contact with this antiferromagnetic layer appears to be magnetized in one direction due to the exchange-coupling with the antiferromagnetic layer; however, in the microscopic sense, the variation in the directions of the crystalline magnetic anisotropy for each crystal grain forming the antiferromagnetic layer causes variation or fluctuation in the magnetization direction of the exchange-coupling magnetic field application layer exchanged-coupled with the antiferromagnetic layer. Among these exchange-coupling magnetic field application layers, because the projection area toward the orthogonal direction to the film surface of the MR laminated body are significantly magnetically affected to the first and second magnetic layers, it is desired that the variation and fluctuation in the magnetization direction is as small as possible. However, since the film dimensions of the projection area in the orthogonal direction to the film surface of the MR laminated body is restricted, the number of crystal grains in the antiferromagnetic layer to be accommodated within the projection area is limited. In particular, in the case that the particle size of the crystal grains forming the antiferromagnetic layer is large, the number of crystal grains accommodated within the projection area shall be smaller. Then, if the number of crystal grains in the antiferromagnetic layer is small, the variation in the crystalline magnetic anisotropy becomes greater. As a result, within this projection area, due to the variation in the direction of the crystalline magnetic anisotropy in the antiferromagnetic layer, the magnetization direction of the exchange-coupling magnetic field application layer which is exchange-coupled with the antiferromagnetic layer varies. In addition, the magnetization directions of the first and second magnetic layers tend to vary.

Then, at least in a portion of the projection area to the orthogonal direction to the film surface of the MR laminated body whose magnetic effect on the first and second magnetic layers is great, if it is designed such that a part of the antiferromagnetic layer is removed to form a void part in the antiferromagnetic layer, the variation and fluctuation in the magnetization direction of the exchange-coupling magnetic filed application layer which is exchange-coupled with the antiferromagnetic layer due to the variation in the direction of the crystalline magnetic anisotropy in the antiferromagnetic layer, can be reduced, and the variation and fluctuation in the magnetization directions of the first and second magnetic layer can be reduced.

Further, if the thickness of the antiferromagnetic layer is thinned to make a thin portion at least in a portion of the projection area, the particle size of the crystalline grains forming the antiferromagnetic layer becomes smaller. As a result, the number of the crystalline grains accommodated within the projection area to the orthogonal direction to the film surface of the MR laminated body whose magnetic effect on the first and second magnetic layers are particularly great, becomes lager. Then, if the number of the crystalline grains in the antiferromagnetic layer becomes larger, the direction of the crystalline magnetic anisotropy is averaged and the variation in the direction of the crystalline magnetic anisotropy becomes smaller. Therefore, the variation and fluctuation in the magnetization direction of the exchange-coupling magnetic field application layer which is exchange-coupled with the antiferromagnetic layer, becomes smaller, and the variation and fluctuation in the magnetization direction of the first and second magnetic layers become smaller.

In an area other than the projection area to the orthogonal direction to the film surface of the MR laminated body, the exchange-coupling magnetic field application layer is magnetically controlled by the antiferromagnetic layer, and thereby, the entire exchange-coupling magnetic field application layer is magnetically controlled. The exchange-coupling magnetic field application layer is not magnetically controlled directly by the antiferromagnetic layer in this projection area; however, due to the effect of the magnetic control in the circumference (in an area other than projection area), the projection area will have a magnetic state similar to that in the circumference. Then, since the first and second magnetic layers are magnetically controlled by this exchange-coupling magnetic field application layer, even if the antiferromagnetic layer does not exist immediately above or below, they are magnetically controlled. Therefore, even if void parts or thin portions exist in the projection area of the antiferromagnetic layer, the original significance to specify the magnetization directions of the first and second magnetic layers will never be impaired. The above descriptions are similarly applied to both the combination of the first antiferromagnetic layer and the first magnetic layer and the combination of the second antiferromagnetic layer and the second magnetic layer.

As described above, a thin film magnetic head where a high rate of change in magneto-resistance can be obtained and where variation in the rate of change in magneto-resistance is small and where reduction of the read gap is easy, can be provided.

The above and other objects, features and advantages of the present invention will become apparent from the following description with reference to the accompanying drawings which illustrate examples of the present invention.

### BRIEF DESCRIPTION OF THE DRAWINGS

FIG. 1 is a side cross sectional view of a thin film magnetic head according to one embodiment of the present invention;

FIG. 2A is a side view of a reading part of the thin film magnetic head viewed from the 2A-2A direction in FIG. 1;

FIG. 2B is a cross sectional view of the reading part of the thin film magnetic head viewed from the same direction as that in FIG. 1;

FIGS. 3A to 3D are schematic views showing a principle of operation of the thin film magnetic head shown in FIG. 1;

FIG. 4 is a graph showing a relationship between magnetic field intensity to be transmitted to the first and second magnetic layers and a signal output;

FIG. 5 is a schematic view showing the configuration of the thin film magnetic head and a principle of operation according to a modified embodiment of the present invention;

FIG. 6 is an enlarged view of main parts schematically showing the exchange-coupling magnetic field application layer making contact with the antiferromagnetic layer;

FIG. 7 is a side view of a reading part of the thin film magnetic head according to another embodiment viewed from the same direction as FIG. 2;

FIG. 8 is a plan view of a wafer relating to a production of the thin film magnetic head of the present invention;

FIG. 9 is a perspective view of the slider of the present invention;

FIG. 10 is a perspective view of the head arm assembly including a head gimbal assembly where the slider of the present invention is incorporated;

FIG. 11 is a side view of the head arm assembly where the slider of the present invention is incorporated; and

FIG. 12 is a plan view of the hard disk device where the slider of the present invention is incorporated.

### DETAILED DESCRIPTION OF THE INVENTION

Hereafter, the thin film magnetic head according to one embodiment of the present invention will be described with reference to drawings.

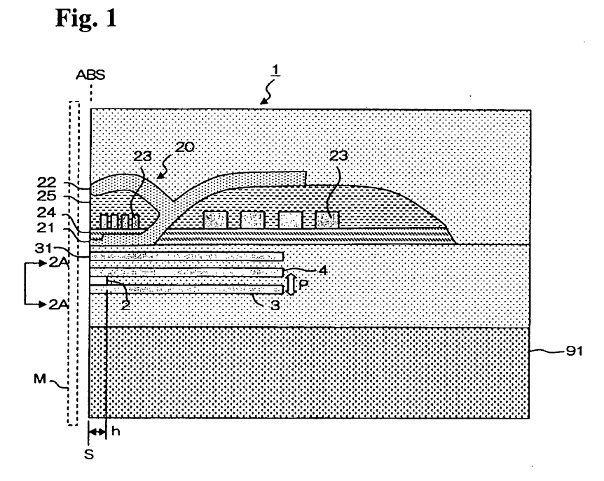

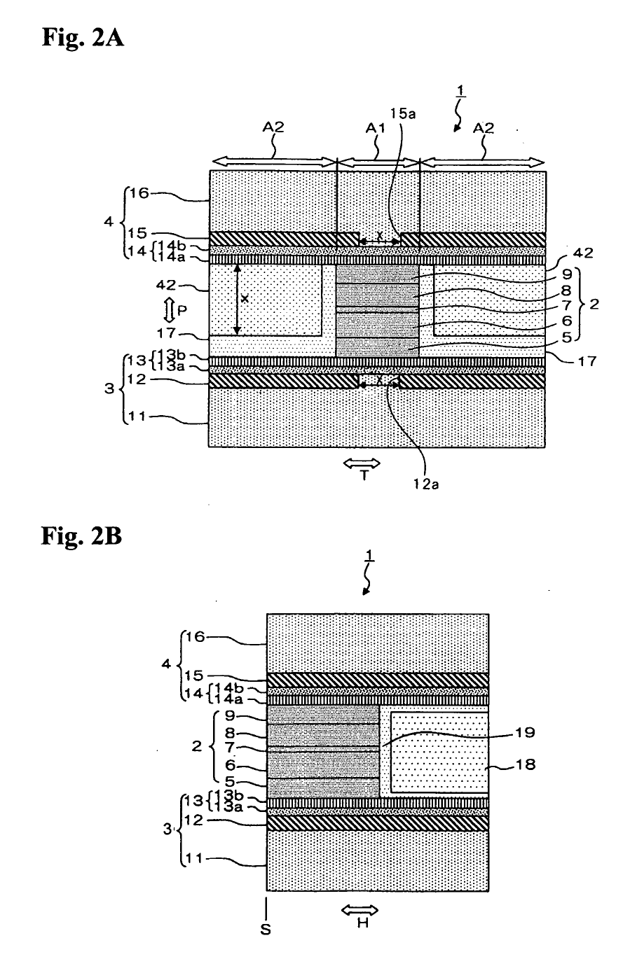

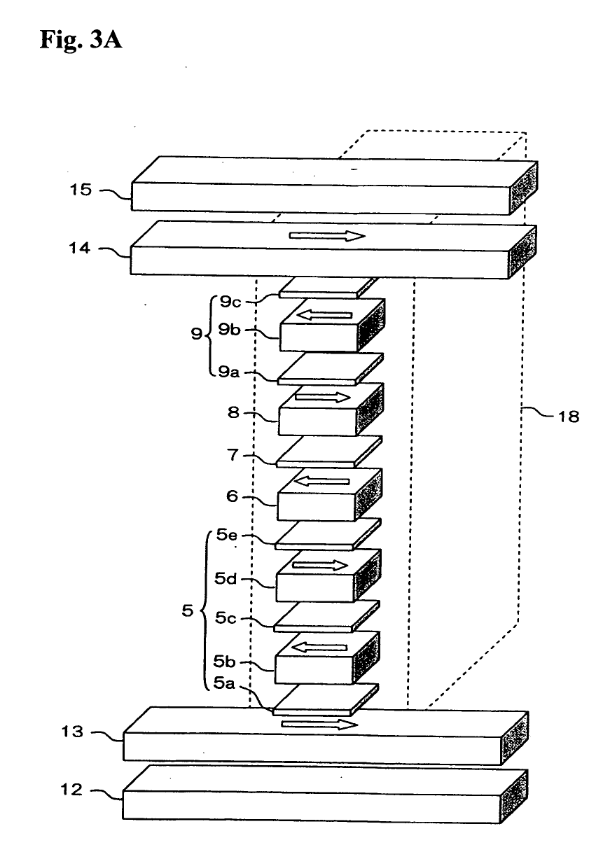

FIG. 1 is a side cross sectional view of the thin film magnetic head of the present embodiment. FIG. 2A is a side view of the reading part of the thin film magnetic head viewed from the 2A-2A direction of FIG. 1, i.e., from the air bearing surface S; and FIG. 2B is a cross sectional view of the reading part of the thing film magnetic head viewed from the same direction as that in FIG. 1. The surface facing a recording medium (also referred to as “floating surface” or “air bearing surface”) S is an opposing surface with the recording medium M in the thing film magnetic head 1.

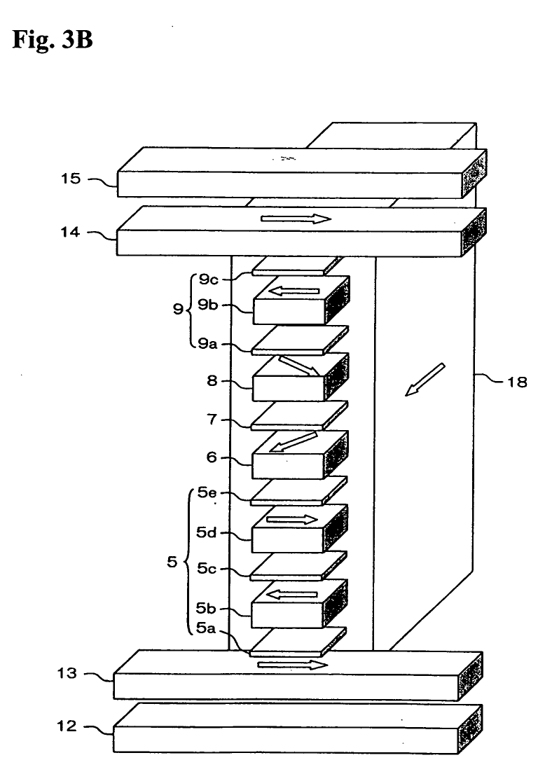

The thin film magnetic head 1 has an MR laminated body 2 and the first and second shield layers 3 and 4 formed in the orthogonal direction P to the film surface of the MR laminated body 2 to interpose the MR laminated body 2. Table 1 shows a film configuration of the MR laminated body 2 and the first shield layer 3 and the second shield layer 4. The table shows layers from the first shield layer 3 toward the second shield layer 4 from bottom up in order. Furthermore, the magnetization direction corresponds to that of FIG. 3A.

TABLE 1

| | | | Thickness | Magnetization |
|---|---|---|---|---|
| Layer composition | | | (nm) | direction |
| Second shield | Second main shield layer | NiFe layer | 1000-2000 | |
| layer 4 | 16 | | | |
| | Second antiferromagnetic | IrMn layer | 0-6 | |
| | layer 15 | | | |
| | Second exchange-coupling | CoFe layer 14b | 2 | → |
| | magnetic field application | NiFe layer 14a | 6 | → |
| | layer 14 | | | |
| MR laminated | Second magnetic coupling | Ru layer 9c | 0.8 | |
| body 2 | layer 9 | CoFe layer 9b | 1 | ← |
| | | Ru layer 9a | 0.8 | |
| | Second magnetic layer 8 | CoFe layer | 5 | → |
| | Nonmagnetic middle layer 7 | ZnO layer | 2.5 | |
| | First magnetic layer 6 | CoFe layer | 5 | ← |
| | First magnetic coupling | Ru later 5e | 0.8 | |
| | layer 5 | CoFe layer 5d | 1 | → |
| | | Ru layer 5c | 0.8 | |
| | | CoFe layer 5b | 1 | ← |
| | | Ru layer 5a | 0.8 | |
| First shield | First exchange-coupling | NiFe layer 13b | 6 | → |
| layer 3 | magnetic field application | CoFe layer 13a | 2 | → |
| | layer 13 | | | |
| | First antiferromagnetic | IrMn layer | 0-6 | |
| | layer 12 | | | |
| | First main shield layer 11 | NiFe layer | 1000-2000 | |

Referring to FIG. 2A and Table 1, the MR laminated body 2 includes a first magnetic layer 6 whose magnetization direction changes according to the external magnetic field, a nonmagnetic middle layer 7, and a second magnetic layer 8 whose magnetization direction changes according to the external magnetic field, and the first magnetic layer 6, the nonmagnetic middle layer 7, and the second magnetic layer 8 make contact with each other in respective order. Further, a first magnetic coupling layer 5 which is adjacent to the first magnetic layer 6, and second magnetic coupling layer 9 which is adjacent to a second magnetic layer 8 are formed.

The first magnetic layer 6 and the second magnetic layer 8 are made of a CoFe layer, and the nonmagnetic middle layer 7 is made of a ZnO layer. The first magnetic layer 6 and the second magnetic layer 8 can be formed with NiFe or CoFeB. The first magnetic layer 6 can also be formed with a two-layer film of NiFe/CoFe, and the second magnetic layer 8 can also be formed with a two-layer film of CoFe/NiFe. Herein, in this specification, the description of A/B/C . . . indicates the films A, B, C . . . are laminated in respective order. In other words, in the case that the first magnetic layer 6 and the second magnetic layer 8 is formed in a two-layer configuration, respectively, it is preferable that the CoFe layer makes contact with the ZnO layer. The nonmagnetic middle layer 7 may be formed with MgO, Al₂O₃, AlN, TiO₂ or NiO. In the case of using metal or a semiconductor, such as ZnO, as the nonmagnetic middle layer 7, the thin film magnetic head 1 functions as a CCP (current perpendicular to the plane)—GMR (giant magneto-resistance) element, and in the case of using an insulator, such as MgO, as the nonmagnetic middle layer 7, the thin film magnetic head functions as a tunneling magneto-resistance (TMR) element.

The first magnetic coupling layer 5 is formed between the first magnetic layer 6 and a first exchange-coupling magnetic field application layer 13 of the first shield layer 3, and as described below, the first magnetic coupling layer 5 has a function to transmit the exchange-coupling magnetic field from the first exchange-coupling magnetic field application layer 13 to the first magnetic layer 6. The first magnetic coupling layer 5 has a laminated constitution of five layers, Ru layer/CoFe layer/Ru layer/CoFe layer/Ru layer, in this embodiment.

Similarly, the second magnetic coupling layer 9 is formed between the second magnetic layer 8 and the second exchange-coupling magnetic field application layer 14 of the second shield layer 4, and as described below, the second magnetic coupling layer 9 has a function to transmit the exchange-coupling magnetic field from the second exchange-coupling magnetic field application layer 14 to the second magnetic field 8. The second magnetic coupling layer 9 has a laminated constitution of three layers, Ru layer/CoFe layer/Ru layer, in this embodiment.

The first shield layer 3 also functions as an electrode for flowing a sense current to the orthogonal direction P to the film surface of the MR laminated body 2, along with the second shield layer 4. The first shield layer 3 is formed at the side facing toward the first magnetic layer 6 via the first magnetic coupling layer 5. The shield layer 3 has a first exchange-coupling magnetic field application layer 13, a first antiferromagnetic layer 12 formed on the rear surface of the first exchange-coupling magnetic field application layer 13 viewed from the first magnetic layer 6 to make contact with the first exchange-coupling magnetic field application layer 13, and a first main shield layer 11 formed on the rear surface of the first antiferromagnetic layer 12 viewed from the first magnetic layer 6. The first exchange-coupling magnetic field application layer 13 has a two-layer constitution with a CoFe layer 13a formed to make contact with the first antiferromagnetic layer 12 and a NiFe layer 13b formed to make contact with both the CoFe layer 13a and the first magnetic coupling layer 5. It is desirable that the thickness of the first exchange-coupling magnetic field application layer 13 is within the range of 5 nm to 80 nm as described below.

The first antiferromagnetic layer 12 of this embodiment is a discontinuous film including a void part 12a (a portion where the first antiferromagnetic layer 12 does not exist) at least in a portion of the position corresponding to the location immediately above the MR laminated body, i.e., in a portion of the projection area to the orthogonal direction P to the film surface of the MR laminated body 2. The technical significance where the first antiferromagnetic layer 12 is formed as a discontinuous layer will be described later. This first antiferromagnetic layer 12 is made of IrMn, and is strongly exchange-coupled with the adjacent CoFe layer 13a. The first antiferromagnetic layer 12 can be formed of alloy, such as Fe—Mn, Ni—Mn, Pt—Mn, or Pd—Pt—Mn, or a combination of these including IrMn, other than the above-mentioned material.

The first main shield layer 11 is made of a NiFe layer, and blocks the external magnetic field from the adjacent bit on the same track of the recording medium M. The configuration of the first main shield layer 11 is the same as a shield layer, which has been well-known, and in general, it has 1 μm to 2 μm of thickness. The first main shield layer 11 is thicker than the first exchange-coupling magnetic field application layer 13 and the first antiferromagnetic layer 12. Then, the first main shield layer 11 is formed partially to be thicker so as to bury the void part 12a of the first antiferromagnetic layer 12. Further, the first main shield layer 11 has a multi-domain structure in general and its permeability is high. Consequently, the first main shield layer 11 effectively function as a shield.

The configuration of the second shield layer 4 is similar to that of the first shield layer 3. In other words, the second shield layer 4 is formed at the side facing toward the second magnetic layer 8 via the second magnetic coupling layer 9. The second shield layer 4 has a second exchange-coupling magnetic field application layer 14, a second antiferromagnetic layer 15 formed on the rear surface of the second exchange-coupling magnetic field application layer 14 viewed from the second magnetic layer 8 to make contact with the second exchange-coupling magnetic field application layer 14, and a second main shield layer 16 formed on the rear surface of the second antiferromagnetic layer 15 viewed from the second magnetic layer 8. The second exchange-coupling magnetic field application layer 14 has a two-layer constitution with a CoFe layer 14b formed to make contact with the second antiferromagnetic layer 15 and a NiFe layer 14a formed to make contact with both the CoFe layer 14b and the second magnetic coupling layer 9. The thickness of the second exchange-coupling magnetic field application layer 14 is within the range of 5 nm to 80 nm.

The second antiferromagnetic layer 15 of this embodiment is a discontinuous film, as similar to the above-mentioned first antiferromagnetic layer 12, including a void part 15a (a portion where the second antiferromagnetic layer 15 does not exist) at least in a portion of the position corresponding to the location immediately above the MR laminated body, i.e., in a portion of the projection area to the orthogonal direction P to the film surface of the MR laminated body 2. The technical significance where the second antiferromagnetic layer 15 is formed as a discontinuous layer will be described later. The second antiferromagnetic layer 15 is made of IrMn, and is strongly exchange-coupled with the adjacent CoFe layer 14b. The second antiferromagnetic layer can be formed with alloy, such as Fe—Mn, Ni—Mn, Pt—Mn, or Pd—Pt—Mn, other than the above-mentioned material.

The second main shield layer 16 is made of a NiFe layer, and blocks the external magnetic field from an adjacent bit on the same track of the recording medium. The configuration of the second main shield layer 16 is the same as a shield layer, which has been well-known, and it has generally 1 μm to 2 μm of thickness. The second main shield layer 16 is thicker than the second exchange-coupling magnetic field application layer 14 and the second antiferromagnetic layer 15. Then, the second main shield layer 16 is formed partially to be thicker so as to bury the void part 15a of the second antiferromagnetic layer 15. Further, the second main shield layer 16 has a multi-domain structure in general and its permeability is high. Consequently, the second main shield layer effectively functions as a shield.

The first and second shield layers 3 and 4 and the first and second antiferromagnetic layer 12 and 15 make contact with the CoFe layers 13a and 14b of the first and second exchange-coupling magnetic field application layers 13 and 14, respectively. This is for securing great exchange-coupling intensity with the first and second antiferromagnetic layers 12 and 15. If the first and second antiferromagnetic layers 12 and 15 make contact with the NiFe layers 13b and 14a, the exchange-coupling intensity becomes smaller and it becomes difficult to solidly secure the magnetization directions of the first and second exchange-coupling magnetic field application layer 13 and 14 by the first and second antiferromagnetic layers 12 and 15. The NiFe layers 13b and 14a are formed for improving a soft magnetic property of a shield layer and for effectively demonstrating the function as a shield layer.

A nonmagnetic layer (not shown), such as Cu, may be inserted between the second antiferromagnetic layer 15 and the second main shield layer 16. For the thickness of the nonmagnetic layer, in the case of Cu, approximately 1 nm is sufficient. The insertion of the nonmagnetic layer results in easy multi-domain of the main shield layer 16, and a shield performance to the external magnetic field of the main shield layer 16 is improved. However, in the case of not forming the nonmagnetic layer, it becomes difficult to generate noise due to the movement of the magnetic domain of the main shield layer 16. Therefore, whether or not the nonmagnetic layer is inserted depends upon the design decision.

Seeing FIG. 2A, an insulating layer 17 made of Al₂O₃ is formed at both sides of the track width direction T of the MR laminated body 2. Forming the insulating layer 17 enables concentration of the sense current flowing in the orthogonal direction P to the film surface of the MR laminated body 2, to the MR laminated body 2. It is acceptable that the insulating layer 17 is formed on the side of the MR laminated body 2 with thickness required for insulation, and an electrically conductive film may exist outside the insulating layer 17. However, even in that case, it is necessary that the first shield layer 3 and the second shield layer 4 are insulated.

A nonmagnetic layer 42 made of Cr, Ta, Ru, CrTi, W, Rh, or Mo etc. is formed between the insulating layer 17 and the second exchange-coupling magnetic field application layer 14.

As shown in FIG. 2B, a bias magnetic field application layer 18, which is a bias magnetic field application means, is formed on the opposite surface to the air bearing surface S of the MR laminated body 2 via an insulating layer 19 made of Al₂O₃. The bias magnetic field application layer 18 is a hard magnetic film made of CoPt, CoCrPt, and so on and applies a bias magnetic field in a direction (height direction H) at right angles to the air bearing surface S, to the MR laminated body 2. The insulating layer 19 prevents the sense current from flowing into the bias magnetic field application layer 18.

Seeing FIG. 1, a writing part 20 is formed on the second shield layer 4 via an inter-element shield layer 31 formed by a sputtering method. The writing part 20 has a so-called perpendicular magnetic recording configuration. The magnetic pole layer for writing is composed of a main magnetic pole layer 21 and an auxiliary magnetic layer 22. These magnetic pole layers 21 and 22 are formed by a frame plating method. The main magnetic pole layer 21 is made of FeCo, and it is exposed on the air bearing surface S in the direction substantially at right angles to the air bearing surface S. A coil layer 23 extending over the gap layer 24 made of an insulating material is wound around the periphery of the main magnetic pole layer 21, and a magnetic flux is induced to the main magnetic layer 21 by the coil layer 23. The coil layer 23 is formed by a flame plating method. This magnetic flux is led to the inside of the main magnetic pole layer 21, and is discharged from the air bearing surface S toward the recording medium. The main magnetic pole layer 21 is narrowed not only in the orthogonal direction P to the film surface but also in the track width direction T (in the direction orthogonal to the paper of FIG. 1; see FIG. 2A, as well), and a minute and strong writing magnetic field corresponding to the high record density is generated.

The auxiliary magnetic layer 22 is a magnetic layer that is magnetically coupled with the main magnetic layer 21. The auxiliary magnetic layer 22 is a magnetic pole layer which has a thickness of approximately 0.01 μm to approximately 0.5 μm and which is formed with alloys of any two or three of Ni, Fe, and Co. The auxiliary magnetic layer 22 is formed to branch from the main magnetic pole layer 21, and faces the main magnetic pole layer 21 at the air bearing surface S side via a gap layer 24 and a coil insulating layer 25. Forming this auxiliary magnetic layer 22 causes more precipitous magnetic field gradient between the auxiliary magnetic layer 22 and the main magnetic pole layer 21 in the vicinity of the air bearing surface S. As a result, jitter of the signal output becomes smaller and an error rate at the time of reading can be reduced.

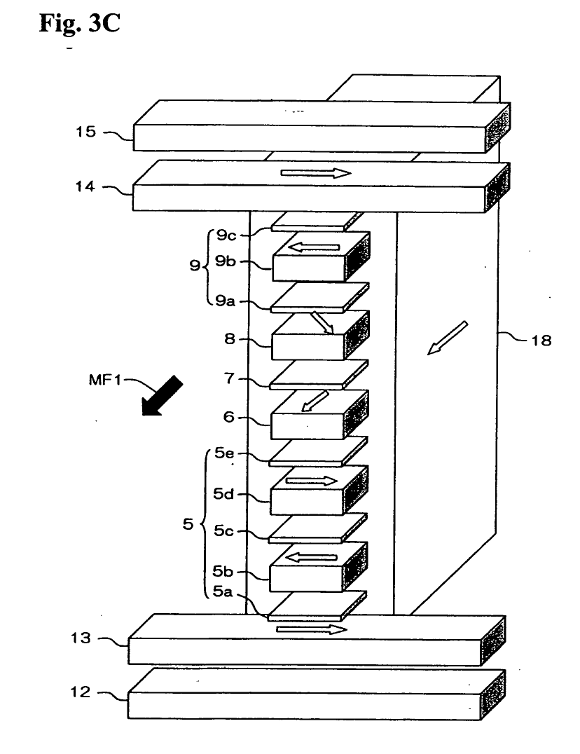

Next, with reference to FIGS. 3A to 3D and FIG. 4, the principle of operation where the thin film magnetic head in this embodiment reads magnetic information recorded in the recording medium will be described. First, magnetic field-free state where both the external magnetic field and a bias magnetic field from the bias magnetic field application layer 18 are not applied is assumed. FIG. 3A is a schematic view showing the magnetization state of the MR laminated body and the shield layer in this virtual state. In order to show that no bias magnetic field is applied, the bias magnetic field application layer 18 is indicated with a broken line. FIG. 4 is a graph showing a relationship between the magnetic field intensity transmitted to the first and second magnetic layers and a signal output. The horizontal axis indicates the magnetic field intensity and the vertical axis indicates the signal output. Furthermore, in each of FIGS. 3A to 3D, an outline arrow indicates the magnetization direction of each magnetic layer.

The first exchange-coupling magnetic field application layer 13 is magnetized to the right side in the drawing due to the exchange-coupling with the first antiferromagnetic layer 12. Similarly, the second exchange-coupling magnetic field application layer 14 is magnetized to the right side in the drawing due to the exchange-coupling with the second antiferromagnetic layer 15.

The first magnetic coupling layer 5 has a laminated constitution with a Ru layer 5a, a CoFe layer 5b, a Ru layer 5c, a CoFe layer 5d, and a Ru layer 5e, and the CoFe layer 5b and the exchange-coupling magnetic field application layer 13 are exchange-coupled via the Ru layer 5a. It is known that the exchange-coupling intensity of Ru indicates a positive or negative value depending upon the thickness, and for example, greatly negative exchange-coupling intensity can be obtained with the film thickness of 0.4 nm, 0.8 nm, and 1.7 nm. Herein, the negative exchange-coupling intensity means that the magnetization directions of the magnetic layers at both sides of the Ru layer are in antiparallel with each other. Therefore, if the thickness of Ru layer 5a is set to these values, the CoFe layer 5b is magnetized toward the left-side in the drawing. Similarly, the CoFe layer 5b and the CoFe layer 5d are exchange-coupled via the Ru layer 5c. In addition, the CoFe layer 5d and the first magnetic layer 6 are exchange-coupled via the Ru layer 5e. If the thickness of the Ru layers 5c and 5e is set, for example, at 0.4 nm, 0.8 nm, or 1.7 nm, the first magnetic layer 6 is magnetized toward the left-side in the drawing. The magnetization directions of the second exchange-coupling magnetic field application layer 14, the second magnetic coupling layer 9, and the second magnetic layer 8 can be similarly considered. Therefore, in the embodiment shown in FIG. 3A, the second magnetic layer 8 is magnetized toward right-side in the drawing.

The state A in FIG. 4 indicates the state in FIG. 3A, and since a bias magnetic field from the bias magnetic field application layer 18 and the external magnetic field from the recording medium M do not exist, a magnetization direction FL1 of the first magnetic layer 6 and a magnetization direction FL2 of the second magnetic layer 8 are antiparallel from each other. However, it is unnecessary that the magnetization direction FL1 of the first magnetic layer 6 and the magnetization direction FL2 of the second magnetic layer 8 do not have to be strictly antiparallel, and it is acceptable as long as the magnetization directions can be rotated in a reverse direction from each other when the bias magnetic field is applied as described below.

As described above, the first magnetic coupling layer 5 magnetically connects the first exchange-coupling magnetic field application layer 13 with the first magnetic layer 6, and the first exchange-coupling magnetic field application layer 13 functions to transmit the exchange-coupling magnetic field in the parallel direction with the air bearing surface S to the first magnetic layer 6 via the first magnetic coupling layer 5. Similarly, the second magnetic coupling layer 9 magnetically connects the second exchange-coupling magnetic field application layer 14 with the second magnetic layer 8, and the second exchange-coupling magnetic field application layer 14 functions to transmit the exchange-coupling magnetic field in the parallel direction with the air bearing surface S to the second magnetic layer 8 via the second magnetic coupling layer 9. As a result, the first magnetic layer 6 and the second magnetic layer 8 are magnetized to an antiparallel direction toward each other in the magnetic field-free state.

Since a bias magnetic field is actually applied to the first magnetic layer 6 and the second magnetic layer 8, next, a state where an external magnetic field is not applied and where only a bias magnetic field is applied as shown in FIG. 3B, is considered. Herein, it is assumed that the bias magnetic field is applied in a direction toward the air bearing surface S. The magnetization directions of the first magnetic layer 6 and the second magnetic layer 8 rotate toward the air bearing surface S by being influenced by the bias magnetic field, respectively. As a result, the magnetization directions of the first magnetic layer 6 and the second magnetic layer 8 rotate from the antiparallel state toward the parallel state, and it becomes in the initial magnetized state (a state where only a bias magnetic field is applied) as the state B shown in FIG. 4. In FIG. 4, for the orientations of the bias magnetic field and the external magnetic field, the downward orientation in the drawing is regarded as positive.

When the external magnetic field from the recording medium M is applied in this state, the relative angle formed with the magnetization direction of the first magnetic layer 6 and that of the second magnetic layer 8 increases or decreases according to the direction of the magnetic field. Specifically, as shown in FIG. 3C, when a magnetic field MF1 that is orientated toward the recording medium M from the air bearing surface S is applied from the recording medium M, the magnetization directions of the first magnetic layer 6 and the second magnetic layer 8 further rotate toward the air bearing surface S, and the magnetization directions of the first magnetic layer 6 and the second magnetic layer 8 are close to the parallel state C (state D in FIG. 4). As approaching the parallel state, it becomes more difficult to scatter electrons which is supplied from the electrodes (the first and second shield layers 3 and 4), and an electrical resistance value to the sense current is decreased. In other words, the signal output is reduced. In the meantime, when the magnetic field MF2 orientated toward the air bearing surface S from the recording medium M is applied as shown in FIG. 3D, inversely, the magnetization directions of the first magnetic layer 6 and the second magnetic layer 8 rotate ward the direction away from the air bearing surface S, and the magnetization directions of the first magnetic layer 6 and the second magnetic layer 8 are close to the antiparallel state (the state E in FIG. 4). The closer the state becomes the antiparallel state, the more easily electrons which are supplied from the electrodes are scattered, and the electrical resistance value to the sense current is increased. In other words, the signal output is increased. As described above, the external magnetic field can be detected by utilizing a change in a relative angle formed with the magnetization directions of the first magnetic layer 6 and the second magnetic layer 8.

Because the magnetization directions of the inside of the first and second magnetic coupling layers 5, 9 are solidly secured due to exchange-coupling, the first and second magnetic coupling layers 5 and 9 are unsusceptible by the external magnetic field. Consequently, the magnetization of the first magnetic layer 6 and the second magnetic layer 8 are unsusceptible by fluctuation in the magnetization directions of the first and second magnetic coupling layers 5 and 9, and the magnetization directions can be changed mainly in response to the external magnetic field.

In this embodiment, thickness, shape, and so on of the bias magnetic field application layer 18 are adjusted in order for the magnetization directions of the first magnetic layer 6 and the second magnetic layer 8 to be at right angles to each other in the state B (initial magnetized state). If the magnetization directions are at right angles to each other in the initial magnetized state, as it is clear from FIG. 4, a change in output (inclination of signal output) according to a change in the external magnetic field becomes greater and a great rate of change in magneto-resistance can be obtained; concurrently, excellent output symmetrical property can be obtained.

As described above, the first and second magnetic coupling layers 5 and 9 have a function to transmit information regarding the magnetization directions of the first and second exchange-coupling magnetic field application layers 13 and 14, particularly, anisotropic properties in the magnetization directions, to the first and second magnetic layers 6 and 8, respectively. However, it requires an attention that the first and second magnetic coupling layers 5 and 9 also have a function to adjust the read gap, respectively. Although a target value of the read gap is determined based upon line recording density to be realized by the thin film magnetic head; however, because the thicknesses of the first and second magnetic layers 6 and 8 and the thickness of the nonmagnetic middle layer 7 are determined according to other various factors, the first and second magnetic coupling layers 5 and 9 have a function to adjust the read gap to a desired size.

The thickness of the Ru layer forming the first and second magnetic coupling layers 5 and 9 has a small degree of freedom as described above, and in order to fix the magnetization direction of the CoFe layer to the external magnetic field, the thickness of the CoFe layer cannot be thickened so much. Then, when the first and second magnetic coupling layers 5 and 9 require greater thickness, it is desirable to increase the number of laminated layers of the Ru layer and the CoFe layer. For example, in this embodiment, the first and second magnetic coupling layers 5 and 9 adopt three-layer configuration with Ru layer/CoFe layer/Ru layer, or five-layer configuration with Ru layer/CoFe layer/Ru layer/CoFe layer/Ru layer; however, other configuration, such as a seven-layer configuration with Ru layer/CoFe layer/Ru layer/CoFe layer/Ru layer/CoFe layer/Ru layer can be used.

When the layer configuration of the first and second magnetic coupling layers 5 and 9 are set, it is desirable to consider the points mentioned below. It is preferable to arrange magnetization directions of the exchange-coupling magnetic field application layers 13 and 14 which are exchange-coupling with the antiferromagnetic layers 12 and 15 in the same direction in view of a magnetizing process. This is because the direction of the exchange-coupling between an antiferromagnetic layer and a ferromagnetic layer is normally determined according to a heat treatment in the magnetic field. Further, it is desirable that the first magnetic layers 6 and the second magnetic layer 8 interposing the nonmagnetic middle layer 7 are magnetized in antiparallel. In this embodiment, in order to fulfill these requirements, the number of combinations of Ru layer/CoFe layer which are exchange-coupled is adjusted. In other words, if the first magnetic coupling layer 5 has the five-layer configuration with Ru layer/CoFe layer/Ru layer/CoFe layer/Ru layer and the second magnetic coupling layer 9 has a three-layer configuration with Ru layer/CoFe layer/Ru layer, the first magnetic layer 6 and the second magnetic layer 8 are magnetized in antiparallel. The first magnetic coupling layer 5 may have a three-layer configuration with Ru layer/CoFe layer/Ru layer and the second magnetic coupling layer 9 may have a five-layer configuration with Ru layer/CoFe layer/Ru layer/CoFe layer/Ru layer.

In the case that the desired read gap is small, it can be considered that either the first magnetic coupling layer 5 or the second magnetic coupling layer 9 has a single layer configuration with the Ru layer. The film configuration when the second magnetic coupling layer 9 has a single configuration with a Ru layer is shown in Table 2. The first magnetic coupling layer 5 has a three-layer configuration with Ru layer/CoFe layer/Ru layer so as to align the magnetization directions of the first and second exchange-coupling magnetic field application layers 13 and 14 that make contact with and are exchange-coupled with the first and second antiferromagnetic layers 12 and 15, and to magnetize the first magnetic layer 6 and the second magnetic layer 8 in antiparallel. It is needless to say, the first magnetic coupling layer 5 can have a single layer configuration with a Ru layer and the second magnetic coupling layer 9 can have a three-layer configuration with Ru layer/CoFe layer/Ru layer. In addition, if the magnetization directions of the first and second exchange-coupling magnetic field application layers 13 and 14 that make contact with and are exchange-coupled with the antiferromagnetic layers 12 and 15 are opposite from each other, it is also possible that both the first and second magnetic coupling layers 5 and 9 can have a single layer configuration with Ru layer.

TABLE 2

| | | | Thickness | Magnetization |
|---|---|---|---|---|
| Layer composition | | | (nm) | direction |
| Second shield | Second main shield layer | NiFe layer | 1000-2000 | |
| layer 4 | 16 | | | |
| | Second antiferromagnetic | IrMn layer | 0-6 | |
| | layer 15 | | | |
| | Second exchange-coupling | CoFe layer 14b | 2 | ← |
| | magnetic field application | NiFe layer 14a | 6 | ← |
| | layer 14 | | | |
| MR laminated | Second magnetic coupling | Ru layer | 0.8 | |
| body 2 | layer 9 | | | |
| | Second magnetic layer 8 | CoFe layer | 5 | → |
| | Nonmagnetic middle layer 7 | ZnO layer | 2.5 | |
| | First magnetic layer 6 | CoFe layer | 5 | ← |
| | First magnetic coupling | Ru layer 5c | 0.8 | |
| | layer 5 | CoFe layer 5b | 1 | → |
| | | Ru layer 5a | 0.8 | |
| First shield | First exchange-coupling | NiFe layer 13b | 6 | ← |
| layer 3 | magnetic field application | CoFe layer 13a | 2 | ← |
| | layer 13 | | | |
| | First antiferromagnetic | IrMn layer | 0-6 | |
| | layer 12 | | | |
| | First main shield layer 11 | NiFe layer | 1000-2000 | |

As described above, in the thin film magnetic head of the present invention, it is possible to be configured to have a magnetic layer (magnetic coupling layer) containing at least one layer of Ru layer at least either between the first magnetic layer 6 and the first exchange-coupling magnetic field application layer 13 or between the second magnetic layer 8 and the second exchange-coupling magnetic field application layer 14. Further, it is also possible to be configured to have a magnetic coupling layer composed of a Ru layer at least either between the first magnetic layer 6 and the first exchange-coupling magnetic field application layer 13 or between the second magnetic layer 8 and the second exchange-coupling magnetic field application layer 14.

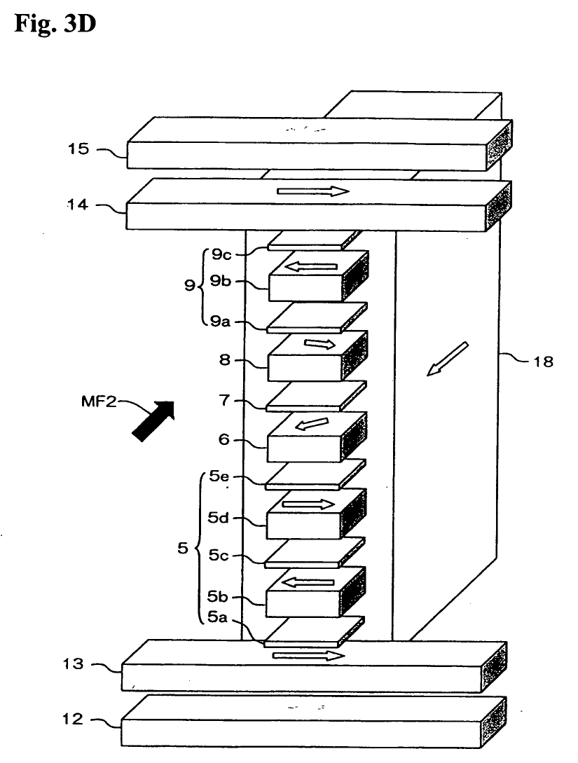

In addition, as shown in FIG. 5, instead of the first exchange-coupling magnetic field application layer 13, a synthetic exchange-coupling magnetic field application layer 41 composed of a pair of ferromagnetic layer 41a and 41c to be exchange-coupled and to interpose a nonmagnetic conductive layer 41b made of Ru may be used. The ferromagnetic layers 41a and 41c are formed with CoFe layer, NiFe layer, or a laminated structure of CoFe layer and NiFe layer. In the case of forming the nonmagnetic conductive layer 41b with a Ru layer, it is preferable that the film thickness is approximately 0.8 nm. Further, it is preferable that a total thickness of the synthetic exchange-coupling magnetic field application layer 41 is approximately 5 nm to 100 nm.

According to this composition, since the magnetization direction is reversed once within the first shield layer 3, the first magnetic coupling layer 5 can be a three-layer composition of Ru layer/CoFe layer/Ru layer. As a result, the film composition and thickness of the first magnetic coupling layer 5 and the second magnetic coupling layer 9 can be matched. Further, as it is clear from the comparison in FIG. 3A and FIG. 5, since the thickness of the first magnetic coupling layer 5 can be reduced, it causes the reduction of lead gap and it further contributes to the high density of recording.

As substitute for the first exchange-coupling magnetic field application layer 13, the second exchange-coupling magnetic field application layer 14 may have a synthetic composition with a ferromagnetic layer/a nonmagnetic conductive layer/a ferromagnetic layer. In short, in the present invention, the film composition of the first magnetic coupling layer 5, the second magnetic coupling layer 9, the first exchange-coupling magnetic field application layer 13, and the second exchange-coupling magnetic field application layer 14 can be appropriately set so as to align the magnetization direction of the first and second exchange-coupling magnetic field application layers 13 and 14 to be exchange-coupled and to make contact with the antiferromagnetic layers 12 and 15, and so as to magnetize the first magnetic layer 6 and the second magnetic layer 8 in antiparallel.

Furthermore, in the case of using a plurality of CoFe layers, it is desirable to conform the thicknesses of CoFe layers to each other. The CoFe layers are magnetized by the external magnetic field and the magnetization direction attempts to rotate toward the external magnetic field; however, if the thicknesses of the CoFe layers are different to each other, the CoFe layers with greater thickness overcome the exchange-coupling force and it becomes easier to rotate, and the function to transmit the information regarding the magnetization direction of the first and second exchange-coupling magnetic field application layers 13 and 14 to the first and second magnetic layers 6 and 8 is inhibited.

In such thin film magnetic head, the first and second magnetic layers 6 and 8, whose directions of magnetization are changed according to the external magnetic field, are magnetized in antiparallel to each other in the magnetic field-free state by the exchange-coupling magnetic field from the first and second exchange-coupling magnetic field application layers 13 and 14 via the first and second magnetic coupling layers 5 and 9. Therefore, it is unnecessary to use a material providing an exchange-coupling effect in the nonmagnetic middle layer 7, and it becomes possible to appropriately use a material that can demonstrate a magneto-resistant effect at maximum, and then, a high rate of change in magneto-resistance can be obtained. Since the first and second exchange-coupling magnetic field application layers 13 and 14 are solidly magnified by the first and second antiferromagnetic layers 12 and 15, the magnetization state of the first and second magnetic layers 6 and 8 are easily controlled and a high rate of change in magneto-resistance with less variation can be obtained. In addition, since the first and second exchange-coupling magnetic field application layers 13 and 14 and the first and second antiferromagnetic layers 12 and 15 provide a function of the shield layers 3 and 4, they also contribute to the reduction of lead gap. In other words, in the thin film magnetic head in this embodiment and in the example, the first and second exchange-coupling magnetic field application layers 13 and 14 and the first and second antiferromagnetic layers 12 and 15 have both a function as a magnetic control layer for controlling the magnetization state of the first and second magnetic layers 6 and 8 and another function as a shield layer.

Next, a composition of the first and second antiferromagnetic layers, which are a main characteristic of the present invention, will be described. As described above, in this embodiment, the first and second antiferromagnetic layers 12 and 15 are a discontinuous film including the void parts 12a and 15a (a portion where the first and second antiferromagnetic layers 12 and 15 do not exist) at least in a portion of the position corresponding to the location immediately above the MR laminated body, i.e., in a portion of the projection area to the direction at right angles to the film surface of the MR laminated body 2, respectively.

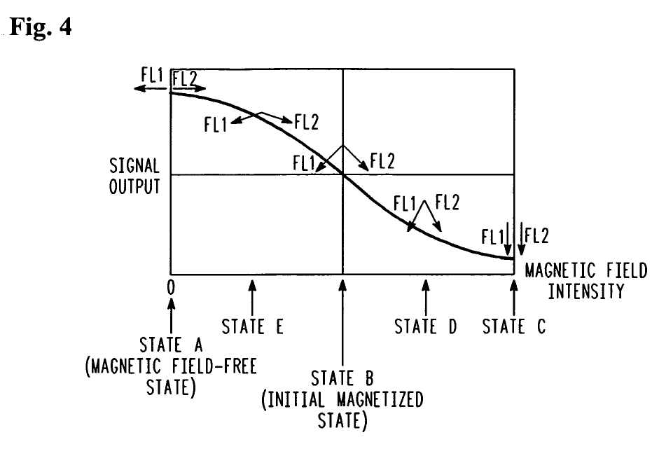

First, explaining a mechanism regarding the exchange-coupling generated between the first and second antiferromagnetic layers 12 and 15 and the first and second exchange-coupling magnetic field application layers 13 and 14, respectively, when the first and second exchange-coupling magnetic field application layers 13 and 14 in contact with the first and second antiferromagnetic layers 12 and 15 are annealed in a state where an external magnetic field is applied, exchange-coupling is generated in the direction of applied magnetic field, and the magnetization of the first and second exchange-coupling magnetic field application layers 13 and 14 is fixed. The upward direction in FIG. 6 is regarded as 0 degree and the angle θ is defined so as to increase in a clockwise direction, and a case where an external magnetic field is applied from the left to the right in the drawing is considered. A magnetization easy axis due to crystalline magnetic anisotropy exists for each grain (crystalline grain) G in the alloy, such as IrMn, and in the exchange-coupling magnetic field application layers 13 and 14 in contact with the alloy, the grain G of the ferromagnetic layers (the exchange-coupling magnetic field application layers 13 and 14) is substantially matched with the grain G of the antiferromagnetic layers 12 and 15, as well, and the exchange-coupling is generated for each grain G. Since the magnetization easy axes of the grain G of the antiferromagnetic layers 12 and 15 is distributed at random, the direction of the exchange-coupling generated between the exchange-coupling magnetic field application layers 13 and 14 also varies. In actuality, the magnetization directions are not perfectly random, but it can be presumed that the magnetization direction 44 of the exchange-coupling magnetic field application layers 13 and 14 is in the state schematically shown in FIG. 6.

If the first and second antiferromagnetic layers 12 and 15 are a continuous film with uniform thickness (for example, 6 nm), in the position corresponding to the location immediately above or below the MR laminated body 2, i.e., in a projection area (the area A1 in FIGS. 2A and 6) to the orthogonal direction P to the film surface of the MR laminated body 2, the grain G is situated the closest to the MR laminated body 2, the exchange magnetic field effectively affects the first and second magnetic layers 6 and 8. The direction of the exchange magnetic field applied to the MR laminated body 2 by the whole grains G within the projection area A1 depends upon the size of individual grain G, but is basically equal to the magnetization directions of the exchange-coupling magnetic field application layers 13 and 14 determined by being affected by the average crystalline magnetic anisotropy of the grains G within the projection area A1. However, because the several grains G exist within the projection area A1, the average orientation of the exchange magnetic field greatly varies for each the magnetic head. For example, in the case of the example shown in FIG. 6, because the angle θ of the grain G is mainly distributed within the range of 90 degrees to 180 degrees, it appears that the average magnetization direction is 120 degrees to 130 degrees, and it is shifted by 30 degrees to 40 degrees with respect to 90 degrees, which is an ideal magnetization direction shown in FIG. 4. In another magnetic head, inversely, the average magnetization direction θ may be approximately 50 degrees to 60 degrees. As a result, the magnetization directions of the first and second magnetic layers 6 and 8 vary in the magnetic field-free state, as well. Consequently, the ideal initial magnetized state B shown in FIG. 4 cannot be obtained, and the rate of change in magneto-resistance is decreased, and further the variation of the rate of change in magneto-resistance is increased. This will not be a problem with the conventional magnetic head that is not involved with the magnetization control of the magnetic layer. However, in the first and second shield layers 3 and 4 that use the second antiferromagnetic layers 12 and 15 to control the magnetization of the first and second magnetic layers 6 and 8, because the state of crystalline magnetic anisotropy in the antiferromagnetic layers 12 and 15 in the vicinity of the MR laminated body 2 directly affects the behavior of the first and second magnetic layers 6 and 8, it is a big problem. In the future, if the width in the track width direction T and the dimension in the height direction H are reduced, this problem becomes more obvious.

Then, in this embodiment, the first and second antiferromagnetic layers 12 and 15 were formed as a discontinuous film having the void parts 12a and 15a, i.e., a discontinuous film in which the first and second antiferromagnetic layers 12 and 15 do not exist in a portion of the position (projection area A1) corresponding to the location immediately above or below the MR laminated body 2, and in such a position, an exchange magnetic field is most effectively applied to the first and second magnetic fields 6 and 8. With this composition, variation in the magnetization direction of the first and second magnetic layers 6 and 8 in a magnetic field-free state due to the variation of magnetization directions of grains G within the projection area Al is prevented, and in association with this, the variation in a rate of change in magneto-resistance can also be reduced.

In the section (area A2) other than the projection area A1, as similar to the prior art, the antiferromagnetic layers 12 and 14 with appropriate thickness (for example, 6 nm) exist, and control the magnetization of the first and second exchange-coupling magnetic field application layers 13 and 14 in contact with the antiferromagnetic layers 12 and 14. As described above, in the area A2 other than the projection area A1, the first and second exchange-coupling magnetic field application layers 13 and 14 are magnetically controlled by the first and second antiferromagnetic layers 12 and 15, and it results in the magnetic control of the entire first and second exchange-coupling magnetic field application layers 13 and 14. Although the first and second exchange-coupling magnetic field application layers 13 and 14 are not magnetically controlled directly by the first and second antiferromagnetic layers 12 and 14 in the projection area A1, they become in the magnetization state similar to the state of the circumference area A2, even within the projection area A1, due to the effect of magnetic control of the circumference area A2. Then, since the first and second magnetic layers 6 and 8 are magnetically controlled by the first and second exchange-coupling magnetic field application layers 13 and 14, even if the first and second antiferromagnetic layers 12 and 15 do not exist immediately above or below, they are magnetically controlled. Therefore, even if the void parts 12a and 15a exist in the projection area Al of the first and second antiferromagnetic layers 12 and 14, the original significance to specify the magnetization directions of the first and second magnetic layers 12 and 15 will not be impaired. Then, the magnetization directions of the first and second magnetic layers 6 and 8 within the projection area A1 do not greatly vary.

The thin film magnetic head in this embodiment can be produced with the method mentioned below. First, the first shield layer 3 is prepared on a substrate 91 (see FIG. 1), and next, each layer constructing the MR laminated body 2 is formed on the first shield layer 3 by the sputtering method. Next, these layers are patterned, respectively, and portions at both sides of the track width direction T are buried with the insulating film 17. After that, it is partially milled from the air bearing surface S so that a section corresponding to the element height h (see FIG. 1) is left, and the bias magnetic field application layer 18 is formed via the insulating layer 19. As described above, the insulating layer 17 is formed on the both sides of the MR laminated body 2 in the track width direction T, and the bias magnetic field application layer 18 is formed on the rear surface of the MR laminated body 2 viewed from the air bearing surface S. After that, the second shield layer 4 is formed. In addition, the above-mentioned writing part 20 is formed with a well-known technique.

More specifically describing, after the first main shield layer 11 whose thickness is thicker than a desired thickness by 6nm was formed on an ALTiC (Al₂O₃—TiC) substrate using a DC magnetron sputtering device, milling was conducted to thinner by 6nm in the area A2 other than the projection area A1. After the IrMn alloy was accumulated by 6nm over the main shield layer 11, flattening was conducted so as to align the positions of the upper surface, and the first antiferromagnetic layer 12, which is a discontinuous film having the void part 12a in the projection area A1, was formed. Next, a CoFe alloy with 2 nm of thickness and a NiFe alloy with 6 nm of thickness were accumulated in respective order, and the first exchange-coupling magnetic field application layer 13 was formed. A multilayer film where Ru layers with 0.8 nm of thickness and CoFe alloys with 1 nm of thickness were alternately positioned, was formed over the first exchange-coupling magnetic field application layer 13 to construct the first magnetic coupling layer 5. The first magnetic layer 6 with 5 nm of thickness, the nonmagnetic middle layer 7 made of ZnO with 2.5 nm of thickness, and the second magnetic layer 8 with 5 nm of thickness were accumulated over the first magnetic coupling layer 5 in respective order. Then, the second magnetic coupling layer 9, which is a similar multilayer film to the first magnetic coupling layer 5 (however, the number of laminated layers is different from that in the first magnetic coupling layer 5), and milling was conducted and a reproducing head shape was obtained. In addition, a NiFe alloy with 6 nm of thickness and a CoFe alloy with 2 nm of thickness were accumulated in respective order to construct the second exchange-coupling magnetic field application layer 14. After an IrMn alloy that is thicker than a desired thickness by 6 nm was accumulated over the second exchange-coupling magnetic field application layer 14, milling was conducted in the projection area A1 was conducted and the IrMn alloy was partially removed. With this process, the antiferromagnetic layer 15, which is a discontinuous layer having the void part 15a in the projection area A1 was formed. After that, a NiFe alloy with 1 μm to 2 μm of thickness was accumulated to construct the second main shield layer 16, and flattening was conducted so as to align the positions of the upper surface. Then, anneal was applied in the magnetic field at 250 degrees C. for three hours.

In the above-mentioned description, as shown in FIG. 2, both the first and second antiferromagnetic layers 12 and 15 are configured as a discontinuous film; however, even in the case that either the first antiferromagnetic layer 12 or the second antiferromagnetic layer 15 is a discontinuous film, some effect can be obtained. This point will be described in explanations for examples and comparative examples.

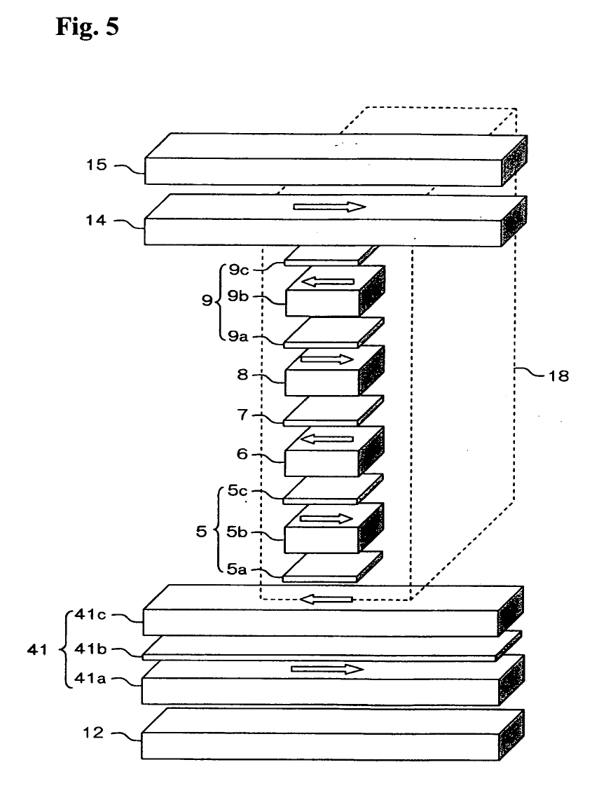

In other embodiment of the present invention, as shown in FIG. 7, the first and second antiferromagnetic layers 12 and 15 are formed not as a discontinuous film but a continuous film, and instead, at least portions corresponding to the location immediately above and below (projection area A1) of the first and second antiferromagnetic layers 12 and 15 are formed as the thin portions 12b and 15, which are thinner than other portion (area A2), respectively. Since other composition is similar to that in the above-mentioned first embodiment, the description will be omitted. Even in this configuration, as similar to the above-mentioned embodiment, an effect where the magnetization of the first and second magnetic layers 6 and 8 is certainly controlled and the magnetization direction shall not greatly vary, is provided. Specifically, the first and second antiferromagnetic layers 12 and 15 are thinned to make the thin portions 12b and 15, and the particle size of the crystalline grains forming the first and second antiferromagnetic layers 12 and 15 becomes smaller at least in these thin portions 12b and 15b. As a result, because the number of crystalline grains accommodated within the projection area A1 toward the orthogonal direction to the film surface of the MR laminated body 2, the crystalline magnetic anisotropy is averaged and the variation in the direction of the crystalline magnetic anisotropy becomes smaller. Therefore, the variation and fluctuation in the magnetization direction of the first and second exchange-coupling magnetic field application layers 13 and 14 magnetically controlled by the first and second antiferromagnetic layers 12 and 14 become smaller, and in addition, the variation and fluctuation in the magnetization direction of the first and second magnetic layers 6 and 8 become smaller, respectively.

Furthermore, in the example shown in FIG. 7, both the first and second antiferromagnetic layers 12 and 15 are thinned and the thin portions 12b and 15b are provided, respectively; however, even in the composition where only either the first antiferromagnetic layer 12 or the second antiferromagnetic layer 15 is partially thinned and the thin portion 12b or 15b is provided, some effect can be obtained. This point will be described in explanations for examples and comparative examples described later.

Herein, in the above-mentioned two embodiments, dimensions of the void parts 12a and 15a and the thin portions 12b and 15b of the first and second antiferromagnetic layers 12 and 15, which are necessary in order to achieve the effect of this invention, will be examined based upon various examples and comparative examples. Furthermore, in the examples mentioned below, the planar shapes of the void parts 12a and 15a and the thin portions 12b and 15b are quadrangles having a distance X of the length of a side in a width direction and 200 nm of length of a side (not shown) in the direction perpendicular to the width direction.

First, as Comparative Example 1, a thin film magnetic head in the case that both the first and second antiferromagnetic layers 12 and 15 were a continuous film having a uniform thickness, respectively, i.e., a thin film magnetic head with a configuration where the void parts 12a and 15a and the thin portions 12b and 15b do not exist both in the first and second antiferromagnetic layers 12 and 15 was produced. The layer composition of this thin film magnetic head is the same as that shown in Table 1, and the MR laminated body 2 is a quadratic prism whose planar shape is a rectangle with 40 nm×200 nm. In this comparative example, as shown in Table 3, the MR ratio was 18.9%, and a value σ/avg where a standard deviation a was divided by an average value avg was 11.3%. These values were used as references for evaluating the MR ratio and σ/avg in examples and other comparative examples. Further, the exchange-coupling intensity Hex was 500 Oe.

In order to facilitate the comparison, Table 3 shows results of all examples and comparative examples.

TABLE 3

| | | | | | | | Relative value |
|---|---|---|---|---|---|---|---|
| | | | Distance X | | Relative value | Standard | when |
| | Layer where | Thickness Y | of void part | | when | deviation/ | Comparative |
| | void part or | of void part | or thin | MR | Comparative | average | Example 1 |
| | thin portion | or thin | portion | ratio | Example 1 was | value | was regarded |
| | was formed | portion (nm) | (nm) | (%) | regarded as 1 | σ/avg (%) | as 1 |
| Comparative | None | 6.0 | 0 | 18.9 | 1.00 | 11.3 | 1.00 |
| Example 1 | | | | | | | |
| Example 1 | SAL*¹ | 0.0 | 10 | 19.3 | 1.02 | 11.5 | 1.02 |
| Example 2 | SAL | 0.0 | 20 | 20.0 | 1.06 | 6.7 | 0.59 |
| Example 3 | SAL | 0.0 | 40 | 19.8 | 1.05 | 4.9 | 0.43 |
| Example 4 | SAL | 0.0 | 80 | 19.3 | 1.02 | 5.4 | 0.48 |
| Example 5 | SAL | 0.0 | 120 | 18.9 | 1.00 | 6.3 | 0.56 |
| Example 6 | SAL | 0.0 | 180 | 18.1 | 0.96 | 8.7 | 0.77 |
| Example 7 | SAL | 0.0 | 200 | 18.0 | 0.95 | 9.6 | 0.85 |
| Comparative | SAL | 0.0 | 220 | 17.0 | 0.90 | 17.0 | 1.50 |
| Example 2 | | | | | | | |
| Example 8 | Both | 0.0 | 80/80 | 19.7 | 1.04 | 3.9 | 0.35 |
| | antiferromagnetic | | | | | | |
| | layers | | | | | | |
| Example 9 | SAL | 1.5 | 10 | 19.1 | 1.01 | 11.3 | 1.00 |
| Example 10 | SAL | 1.5 | 20 | 19.3 | 1.02 | 7.1 | 0.63 |
| Example 11 | SAL | 1.5 | 40 | 19.5 | 1.03 | 5.8 | 0.51 |
| Example 12 | SAL | 1.5 | 120 | 19.3 | 1.02 | 6.7 | 0.59 |
| Example 13 | SAL | 1.5 | 200 | 17.6 | 0.93 | 9.8 | 0.87 |
| Comparative | SAL | 1.5 | 220 | 16.6 | 0.88 | 16.3 | 1.44 |
| Example 3 | | | | | | | |
| Example 14 | SAL | 2.0 | 40 | 19.7 | 1.04 | 7.6 | 0.67 |
| Example 15 | SAL | 2.5 | 40 | 19.5 | 1.03 | 8.9 | 0.79 |
| Comparative | SAL | 3.0 | 40 | 19.7 | 1.04 | 12.5 | 1.11 |
| Example 4 | | | | | | | |
| Example 16 | FAL*² | 1.5 | 40 | 19.7 | 1.04 | 5.1 | 0.45 |
| Example 17 | FAL | 1.5 | 80 | 19.5 | 1.03 | 5.8 | 0.51 |
| Example 18 | Both | 1.5 | 80/80 | 19.5 | 1.03 | 4.4 | 0.39 |
| | antiferromagnetic | | | | | | |
| | layers | | | | | | |

*¹SAL: Second antiferromagnetic layer
*²FAL: First antiferromagnetic layer

Next, a plurality of thin film magnetic heads that have a configuration where the first antiferromagnetic layer 12 was a continuous film with uniform thickness and only the second antiferromagnetic layer 15 was a discontinuous film, and where the distance X in the width direction (horizontal direction in FIG. 2A) of the void part 15a (a portion where IrMn forming the second antiferromagnetic layer 15 is removed) was variously changed were produced. Specifically, eight types of thin film magnetic heads whose distance X was changed to 10 nm, 20 nm, 40 nm, 80 nm, 120 nm, 180 nm, 200 nm, and 200 nm were produced. In those thin film magnetic head, the configuration other than the second antiferromagnetic layer 15 is completely the same.

According to the result shown in Table 3, if the distance X of the void part 15a of the second antiferromagnetic layer 15 is within the range between 10 nm and 200 nm, the MR ratio is substantially the same compared to that in Comparative Example 1 where no void part exists; concurrently, the variation in the MR ratio expressed with the standard deviation/average value (σ/avg) is the same level or less. Then, examples where the distance X of the void part 15a is 10 nm, 20 nm, 40 nm, 80 nm, 120 nm, 180 nm, or 200 nm are regarded as Examples 1 to 7 of the present invention. In the meantime, in the example where the distance X of the void part 15a is 220 nm, the MR ratio is smaller than Comparative Example 1, and in addition, variation in the MR ratio is considerably great. Therefore, this example is considered as Comparative Example 2.

According to Table 3, from the viewpoint where the MR ratio is improved compared to Comparative Example 1, Examples 1 to 4, i.e., the range between 10 nm to 80 nm of the distance X of the void part 15a is preferable, and from the viewpoint where the variation in the MR ratio becomes smaller compared to Comparative Example 1, Examples 2 to 7, i.e., the range between 20 nm to 200 nm of the distance X of the void part 15a is preferable. In other words, it is preferable that the distance X of the void part 15a is within the range between ½ times and 5 times the width of the MR laminated body 2. In addition, Example 2 to 4, which simultaneously accomplish the improvement of the MR ratio and reduction of variation in MR ratio, i.e., the range between 20 nm and 80 nm of the distance X of the void part 15a is particularly preferable.

Furthermore, Examples 1 to 7 and Comparative Examples 1 to 2 are all configured such that only the second antiferromagnetic layer 15 is a discontinuous film and the first antiferromagnetic layer 12 is a continuous film whose thickness is uniform. However, even in the case of the configuration where only the first antiferromagnetic layer 12 is a discontinuous film, theoretically, it appears that substantially the same results as those in the examples and the reference examples can be obtained.

Further, as Example 8, a thin film magnetic head with the configuration where both the first antiferromagnetic layer 12 and the second antiferromagnetic layer 15 were a discontinuous film, respectively, as similar to FIG. 2A was produced. As shown in Table 3, in the case of Example 8, regarding both effects in the improvement of MR ratio and in reduction of the variation in MR ratio, extremely superior results were obtained.

Next, with the configuration where the first antiferromagnetic layer 12 was a continuous film with uniform thickness and the second antiferromagnetic layer 15 was thinned to make the thin portion 12b, a plurality of thin film magnetic heads whose distance X in the width direction (horizontal direction in FIG. 2A) was variously changed were produced. Specifically, six types of thin film magnetic heads whose thickness Y of the thin portion 15b was 1.5 nm, and whose distance X of the thin portion 15b was 10 nm, 20 nm, 40 nm, 120 nm, 200 nm, or 220 nm were produced. The configuration of these thin film magnetic heads are completely the same except for the second antiferromagnetic layer 15.

According to the results shown in Table 3, within the range between 10 nm and 200 nm of the distance X of the thin portion 15b in the second antiferromagnetic layer 15, the MR ratio is substantially the same compared to Comparative Example 1 where no thin portion exists; concurrently, the variation in the MR ratio expressed with the standard deviation/average value (σ/avg) is the same level or less. Then, examples whose distance X of the thin portion 15b is 10 nm, 20 nm, 40 nm, 120 nm, or 200 nm are considered as Example 9 to 13 of the present invention. In the meantime, in the example whose distance X of the thin portion 15b is 220 nm, the MR ratio is smaller than that in Comparative Example 1, and in addition, the variation in the MR ratio is considerably great. Therefore, this example is considered as Comparative Example 3.

According to Table 3, from the viewpoint where the MR ratio is improved compared to Comparative Example 1, Examples 9 to 12, i.e., the range between 10 nm to 120 nm of the distance X of the thin portion 15b is preferable, and from the viewpoint where the variation in the MR ratio becomes smaller compared to Comparative Example 1, Examples 10 to 13, i.e., the range between 20 nm to 200 nm of the distance X of the thin portion 15b is preferable. In other words, it is preferable that the distance X of the thin portion 15b is within the range between ½ times and 5 times the width of the MR laminated body 2. In addition, Example 10 to 12, which simultaneously accomplish the improvement of the MR ratio and reduction of variation in MR ratio, i.e., the range between 20 nm and 120 nm of the distance X of the thin portion 15b is particularly preferable.

Further, as a modified example of Example 11, a plurality of thin film magnetic heads that had a configuration where the first antiferromagnetic layer 12 was a continuous film with uniform thickness and the second antiferromagnetic layer 15 was thinned, and where the distance X of the thin portion 15b in the width direction (horizontal direction in FIG. 2A) was constant and the thickness Y was variously changed were produced. Specifically, three types of thin film magnetic heads where the distance X of the thin portion 15b was 40 nm and the thickness Y of the thin portion 15b was 2.0 nm, 2.5 nm, or 3.0 nm were produced. The configuration of those thin film magnetic heads is completely the same except for the second antiferromagnetic layer 15.

According to the results shown in Table 3, examining the results including that of Example 11, in the case that the distance X of the thin portion 15b in the second antiferromagnetic layer 15 is 40 nm, if the thickness is within the range between 1.5 nm and 2.5 nm, the MR ratio is substantially the same compared to Comparative Example 1 where no thin portion 15b exists; concurrently, the variation in MR ratio expressed with the standard deviation/average value (σ/avg) is the same level or less. Then, the examples whose thickness Y of the thin portion 15b is 2.0 nm and 2.5 nm are considered as Examples 14 to 15 of the present invention. In the meantime, in the example whose thickness Y of the thin portion 15b is 3.0 nm, although the MR ratio is greater than that in Comparative Example 1, the variation in the MR ratio is great. Therefore, this example is considered as Comparative Example 4.

According to Table 3, Examples 11, 14 and 15, which simultaneously accomplish the improvement of the MR ratio and reduction of variation in MR ratio, i.e., the configuration with the range between 1.5 nm and 2.5 nm of the thickness Y of the thin portion 15b is very preferable.

In all of the above-mentioned Examples 9 to 15 and Comparative Examples 3 to 5, only the second antiferromagnetic layer 15 is partially thinned; however, the first antiferromagnetic layer 12 is a continuous film with uniform thickness. However, even in the case of the configuration where the first antiferromagnetic layer 12 is partially thinned, theoretically, it appears that substantially the same results as those in the examples and the comparative examples can be obtained. Then, a thin film magnetic head with a configuration where the second antiferromagnetic layer 15 was a continuous film with uniform thickness and only the first antiferromagnetic layer 12 was partially thinned to have the thin portion 12b was produced. Specifically, two types of thin film magnetic heads where the thickness Y of the thin portion 12b of the first antiferromagnetic layer 12 was 1.5 nm and the distance X was 40 nm or 80 nm were produced. The configuration of those thin film magnetic head is completely the same except for the first antiferromagnetic layer 12.

According to the results shown in Table 3, in the case that the thickness Y of the thin portion 12b in the first antiferromagnetic layer 12 was 1.5 nm and the distance X was 40 nm, excellent results, which are substantially the same as those in Embodiment 11, were obtained. In other words, as described above, it was demonstrated that the substantially the same effect was able to be obtained with the configuration where only the second antiferromagnetic layer 15 was partially thinned and the configuration where only the first antiferromagnetic layer 12 was thinned. In addition, even in the case that the thickness Y of the thin portion 12b of the first antiferromagnetic layer 12 was 1.5 nm and the distance X of the thin portion 12b was 80 nm, the excellent result, which is substantially the same as that for Example 11, was obtained. Then, these configurations are considered as Examples 16 and 17 of the present invention.,

In addition, a thin film magnetic head with a configuration where both the first antiferromagnetic layer 12 and the second antiferromagnetic layer 15 were partially thinned to have the thin portions 12b and 15b, respectively, was produced. Specifically, the thickness Y of the thin portions 12b and 15b of both the antiferromagnetic layers 12 and 15 is both 1.5 nm, and the distance X is both 80 nm. According to Table 3, compared to any of Examples 9 to 17 and the Comparative Examples 3 to 4, while the substantially the same level of the MR ratio is obtained and the variation of the MR ratio is restrained at extremely small, and a very preferably result is obtained. This configuration is considered as Example 18 of the present invention.

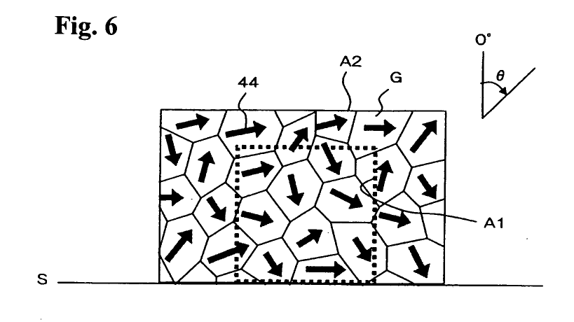

Next, a wafer used for production of the above-mentioned thin film magnetic head will be described. Seeing FIG. 8, a laminated body composing at least the above-mentioned thin film magnetic head is formed over a wafer 100. The wafer 100 is divided into a plurality of bars 101, which are an operating unit on the occasion of polishing processing or the air bearing surface S. The bars 101 are further cut after the polishing processing, and divided into sliders 210 including the thin film magnetic head. Margins (not shown) for cutting the wafer 100 into the bars 101 and for cutting the bars 101 into the sliders 210 are prepared in the wafer 100.

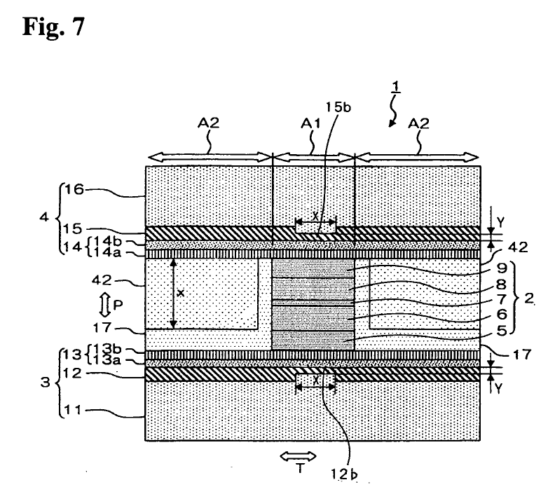

Seeing FIG. 9, the slider 210 has substantially a hexahedral shape, and its one surface is the air bearing surface S opposing to a hard disk.

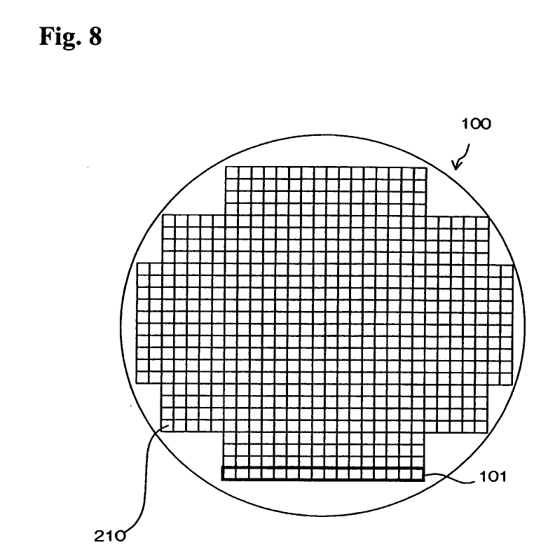

Seeing FIG. 10, a head gimbal assembly 220 is equipped with a slider 210 and a suspension 221 for elastically supporting the slider 210. The suspension 221 has a plate spring-shaped load beam 222 formed from stainless steel, a flexure 223 formed at one end of the load beam 22 and a base plate 224 formed at the other end of the load beam 222. The slider 210 is joined with the flexure 223, and the flexure provides the slider 210 appropriate degree of freedom. A gimbal part for maintaining a posture of the slider to be constant is formed in the portion where the slider is mounted.

The slider 210 is arranged within the hard disk device so as to face against the hard disk, which is a disc-shaped recording medium to be revolved. When the hard disk revolved in the z-direction in FIG. 10, a lift force is generated to the slider 210 downward in the y-direction by airflow passing between the hard disk and the slider 210. The slider 210 is designed to float from the surface of the hard disk by this lift force. The thin film magnetic head 1 is formed in the vicinity of the end (end portion in the lower left in FIG. 9) at the airflow side of the slider 210.

A component where the head gimbal assembly 220 is mounted to an arm 230 is referred to as a head arm assembly 221. The arm 230 moves the slider 210 in the track trasverse direction x of the hard disk 262. One end of the arm 230 is mounted to the base plate 224. A coil 231, which is a portion of the voice coil motor, is mounted to the other end of the arm 230. A bearing part 233 is formed in the intermediate portion of the arm 230. The arm 230 is rotatably supported by a shaft 234 mounted to the bearing part 233. The arm 230 and the voice coil motor for driving the arm 230 construct an actuator.

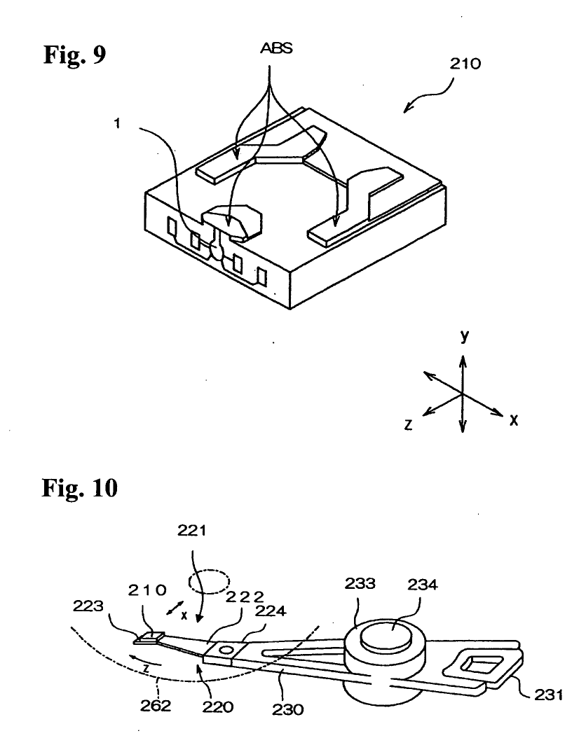

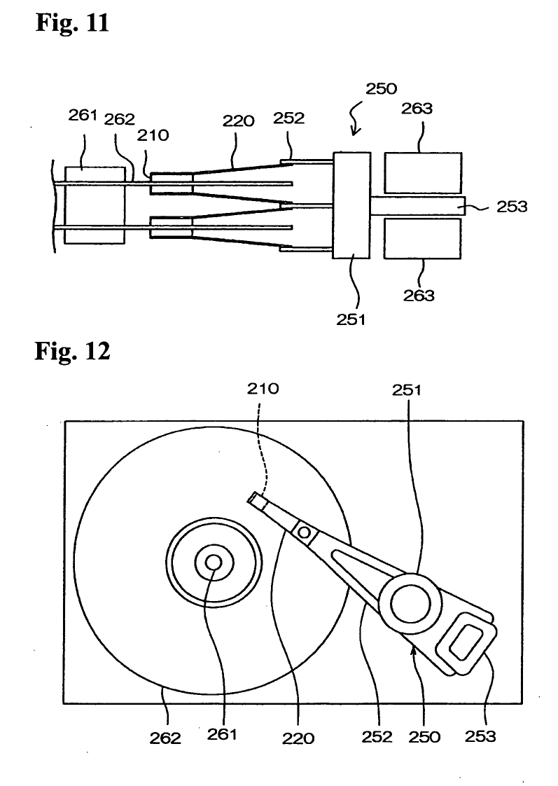

Next, seeing FIG. 11 and FIG. 12, a head stack assembly where the above-mentioned slider is incorporated and the hard disk device will be described. The head stack assembly is an assembly where the head gimbal assemblies 220 are mounted to each arm of the carriage having a plurality of arms, respectively. FIG. 11 is a side view of the head stack assembly, and FIG. 12 is a plan view of the hard disk device. The head stack assembly 250 has a carriage 251 having a plurality of arms 252. The head gimbal assemblies 220 are mounted to each arm 252 so as to align vertically at intervals. A coil 253, which is a portion of the voice coil motor, is mounted to the opposite side of the carriage 251 to the arm 252. The voice coil motor has permanent magnets 263 arranged at opposing positions to interpose the coil 253.

Seeing FIG. 12, the head stack assembly 250 is incorporated into the hard disk device. The hard disk device has a plurality of hard discs 262 mounted to spindle motors 261, respectively. Two sliders 210 are arranged so as to interpose the hard disk 262 and to face toward each other for each hard disk 262. The head stack assembly 250 except for the slider 210 and the actuator, which correspond to a positioning device in the present invention, support the slider 210 and position the slider 210 relative to the hard disk 262. The slider 210 is moved in the track transverse direction of the hard disk 262 by the actuator, and is positioned relative to the hard disk 262. The thin film magnetic head 1 contained in the slider 210 records information into the hard disk 262 by the recording head, and reproduces the information recorded in the hard disk 262 by the reproducing head.

While preferred embodiments of the present invention have been presented and described in detail, it is to be understood that changes and variations may be made without departing from the spirit or scope of the following claims.

What is claimed is:

1. A thin film magnetic head, comprising
an MR laminated body that has a first magnetic layer whose magnetization direction is changed according to an external magnetic field, a nonmagnetic middle layer, and a second magnetic layer whose magnetization direction is changed according to the external magnetic field, and where said first magnetic layer, said nonmagnetic middle layer, and said second magnetic layer are laminated to make contact with each other in respective order,
first and second shield layers each of which is provided to face said first magnetic layer and said second magnetic layer, respectively, and which are arranged in a matter of sandwiching said MR laminated body in an orthogonal direction to a film surface of said MR laminated body, and which function as electrodes for flowing a sense current in the orthogonal direction to the film surface of said MR laminated body; and
a bias magnetic field application means that is formed on an opposite surface from an air bearing surface of said MR laminated body, and that applies a bias magnetic field in the orthogonal direction to said air bearing surface, to said MR laminated body;
said first shield layer having a first exchange-coupling magnetic field application layer that is formed to face said first magnetic layer and that transmits an exchange-coupling magnetic field in parallel to said air bearing surface, to said first magnetic layer, and a first antiferromagnetic layer that is formed on the rear surface of said first exchange-coupling magnetic field application layer viewed from said first magnetic layer to make contact with said first exchange-coupling magnetic field application layer and that is exchange-coupled with said first exchange-coupling magnetic field application layer;
said second shield layer having a second exchange-coupling magnetic field application layer that is formed to face said second magnetic layer and that transmits an exchange-coupling magnetic field in parallel to said air bearing surface; and
a second antiferromagnetic layer is formed on the rear surface of said second exchange-coupling magnetic field application layer viewed from said second magnetic layer to make contact with said second exchange-coupling magnetic field application layer and that is exchange-coupled with said second exchange-coupling magnetic field application layer, and
said first antiferromagnetic layer and/or said second antiferromagnetic layer containing a void part at least in a portion of the projection area toward the orthogonal direction to the film surface of said MR laminated body.

2. The thin film magnetic head according to claim 1, wherein a distance of said void part in a width direction is within a range between 0.5 times and 5.0 times the width of said MR laminated body.

3. The thin film magnetic head according to claim 1, wherein a distance of said void part in a width direction is within a range between 10 nm and 200 nm inclusive.

4. The thin film magnetic head according to claim 1, wherein said bias magnetic field application means is a bias magnetic field application layer.

5. A thin film magnetic head, comprising
an MR laminated body that has a first magnetic layer whose magnetization direction is changed according to an external magnetic field, a nonmagnetic middle layer, and a second magnetic layer whose magnetization direction is changed according to the external magnetic field, and where said first magnetic layer, said nonmagnetic middle layer, and said second magnetic layer are laminated to make contact with each other in respective order,
first and second shield layers each of which is provided to face said first magnetic layer and said second magnetic layer, respectively, and which are arranged in a matter of sandwiching said MR laminated body in an orthogonal direction to a film surface of said MR laminated body, and which function as electrodes for flowing a sense current in the orthogonal direction to the film surface of said MR laminated body; and
a bias magnetic field application means that is formed on an opposite surface from an air bearing surface of said MR laminated body, and that applies a bias magnetic field in the orthogonal direction to said air bearing surface, to said MR laminated body;
said first shield layer having a first exchange-coupling magnetic field application layer that is formed to face said first magnetic layer and that transmits an exchange-coupling magnetic field in parallel to said air bearing surface, to said first magnetic layer, and a first antiferromagnetic layer that is formed on the rear surface of said first exchange-coupling magnetic field application layer viewed from said first magnetic layer to make contact with said first exchange-coupling magnetic field application layer and that is exchange-coupled with said first exchange-coupling magnetic field application layer, and
said second shield layer having a second exchange-coupling magnetic field application layer that is formed to face said second magnetic layer and that transmits an exchange-coupling magnetic field in parallel to said air bearing surface; and
a second antiferromagnetic layer is formed on the rear surface of said second exchange-coupling magnetic field application layer viewed from said second magnetic layer to make contact with said second exchange-coupling magnetic field application layer and that is exchange-coupled with said second exchange-coupling magnetic field application layer; and
said first antiferromagnetic layer and/or said second antiferromagnetic layer containing a thin portion at least in a portion of the projection area toward the orthogonal direction to the film surface of said MR laminated body.

6. The thin film magnetic head according to claim 5, wherein a distance of said thin portion in a width direction is within a range between 0.5 times and 5.0 times the width of said MR laminated body.

7. The thin film magnetic head according to claim 5, wherein a distance of said thin portion in a width direction is within a range between 10 nm and 200 nm inclusive.

8. The thin film magnetic head according to claim 5, wherein a thickness of said thin portion is within a range between 1.5 nm and 2.5 nm inclusive.

9. The thin film magnetic head according to claim 5, wherein said bias magnetic field application means is a bias magnetic field application layer.

10. A slider comprising the thin film magnetic head according to claim 1.

11. A slider comprising the thin film magnetic head according to claim 5.

12. A wafer where a laminated body to be the thin film magnetic head according to claim 1 is formed.

13. A wafer where a laminated body to be the thin film magnetic head according to claim 5 is formed.

14. A head gimbal assembly comprising the slider according to claim 10 and a suspension elastically supporting said slider.

15. A head gimbal assembly comprising the slider according to claim 11 and a suspension elastically supporting said slider.

16. A hard disk device comprising the slider according to claim 10 and a device to support said slider and to position said slider with regard to a recording medium.

17. A hard disk device comprising the slider according to claim 11 and a device to support said slider and to position said the slider with regard to a recording medium.
